(19) United States
(12) Patent Application Publication
(10) Pub. No.: US 2009/0257052 A1
(43) Pub. Date: Oct. 15, 2009

(54) Device for inspecting the quality of a surface

(75) Inventor: Yves SURREL, SAINT ETIENNE (FR)

Correspondence Address: CANTOR COLBURN, LLP, 20 Church Street, 22nd Floor, Hartford, CT, 06103, US

(73) Assignee: VISUOL TECHNOLOGIES, SAINT JULIEN LES METZ (FR)

(21) Appl. No.: 12/421,281

(22) Filed: Apr. 9, 2009

(30) Foreign Application Priority Data
Apr. 11, 2008 (FR) 08/02001

(51) Int. Cl. G01N 21/88

(52) U.S. Cl. 356/237.2

(57) ABSTRACT

This device for inspecting surfaces by deflectometry comprises:
a display device (2) designed to generate, on its face called the front face, a pattern of alternate light and dark fringes;
at least one sensor (3) designed to acquire the image reflected by the surface to be inspected (5) positioned on the front face of the display device and at the periphery of the latter; and
a reflecting means positioned in relation to the surface to be inspected (5) so as to direct the image reflected by the surface to be inspected (5) toward the sensor (3), the display device being oriented in relation to the surface to be inspected at an angle such that the display device is viewed by the sensor at normal incidence.

### TECHNICAL FIELD OF THE INVENTION

The present invention relates to a device for inspecting the quality of a surface.

### BACKGROUND OF THE INVENTION

The inspecting of the quality of a surface can be carried out by the principle of deflectometry.

This principle consists in:
displaying a pattern of straight fringes or lines in the vicinity of an object whose surface is to be inspected; and
capturing and analyzing the image reflected by the surface to be inspected.

Conventionally, a deflectometry inspection device comprises a display device that makes it possible to display a fringe pattern, the characteristics of which are known, in the vicinity of the surface to be inspected and an image sensor, which is generally a CCD camera or an equivalent. Fringes are understood to be a series of alternately light and dark and generally straight bands generated by the display device, which may be black and white or of any other color.

The display device and the image sensor may be housed in a portable case. The mobile use of a deflectometry inspection device requires some compactness of the device.

The downside of this compactness is then a limitation in the size of the surface that can be inspected.

On this subject, document JP 2007/047022 shows a deflectometry inspection device which is able to inspect a small surface. The downside of the relative compactness of the device described in this document is the small size of the surface inspected.

Specifically, the factor limiting the surface to be inspected is the field of the image sensor. For a sensor equipped with a given optics it is necessary to move the image sensor away from the surface to be inspected in order to increase the size of the inspected surface. This is done to the detriment of the size requirement, which in general is not desirable for a portable device. Yet, from an industrial perspective, the size of the surface inspected is critical, as the greater the size of the surface inspected, the more useful the inspection proves to be in industrial practice.

In this technical context, one aim of the invention is therefore to propose a device for inspecting surfaces by deflectometry which, while having a small size requirement, makes it possible to inspect a surface of large size.

### SUMMARY OF THE INVENTION

The invention relates to a device for inspecting surfaces by deflectometry, which comprises:
a display device designed to generate, on its face called the front face, a pattern of alternate light and dark fringes;
at least one sensor designed to acquire the image reflected by the surface to be inspected positioned on the front face of the display device and at the periphery of the latter; and
a reflecting means positioned in relation to the surface to be inspected so as to direct the image reflected by the surface to be inspected toward the sensor, the display device being oriented in relation to the surface to be inspected at an angle such that the display device is viewed by the sensor at normal incidence.

An original provision of the invention is to ensure that the image reflected by the surface to be inspected is deflected toward a sensor which is itself positioned in the vicinity of the display device and which is inclined in relation to the surface to be inspected. The inclination of the display device in relation to the surface to be inspected is an important point of the invention as this makes it possible for the normal to the screen to be parallel to the optical axis. It is thus possible to avoid any distortion of the displayed fringes through the effect of perspective. Thus a device is obtained which is considerably more compact than the devices of the prior art since, according to the invention, the sensor is positioned in the vicinity of the display device, which is the bulkiest element of the device. To recall, in the devices of the prior art, the camera is positioned at a distance from the surface to be inspected that is sufficiently distant to allow the field of the camera in question to cover a significant area of the surface to be inspected. The invention makes it possible to overcome this inherent drawback of the prior art. In practice, the invention makes it possible to fold back the pyramid of light rays reflected by the surface to be inspected toward a sensor that can be located in a position favoring a low overall space requirement of the device. The positioning of the sensor(s) in the space delimited by the display device and the surface to be inspected is an important provision of the invention for the compactness of the device. This provision is extremely advantageous in terms of the size requirement since the back of the display device then does not have any prominent element. The pyramid of reflected rays is then folded back in front of and not behind the display screen, which contributes to the compactness of the assembly.

In a preferred embodiment of the invention, at least one sensor may be oriented in a direction perpendicular to the deflecting mirror or at least one sensor may be oriented in a direction parallel to the deflecting mirror and is associated with a return means, of the mirror type or equivalent, which changes the path of the light rays coming from the deflecting mirror toward the sensor.

In concrete terms, the reflecting means is a deflecting mirror.

Preferably, each of the sensors is mounted directly or indirectly on the display device. The invention makes it possible to use the display device as a sensor support either by fixing the sensor directly on the display device or by fixing the sensor indirectly on the display device by means of struts or fixing lugs.

According to one possibility, at least one sensor is oriented in a direction perpendicular to the deflecting mirror.

In practice, the device may comprise two sensors oriented in the direction of a deflecting mirror.

In concrete terms, the display device may be an LCD screen and the sensor may be a CCD camera.

### BRIEF DESCRIPTION OF THE DRAWINGS

In order to be understood properly, the invention is described with reference to the appended drawing showing, by way of nonlimiting example, several embodiments of an arrangement.

FIGS. 1 to 3 show an inspection device according to a first embodiment in perspective, in a side view and in a view from above respectively.

FIGS. 4 to 6 show an inspection device according to a second embodiment in perspective, in a side view and in a view from above respectively.

As a preliminary, it is pointed out that the drawings show the invention in a schematic manner.

In particular, the drawings show only the essential constituents of the device according to the invention and, for greater clarity, leave out, for example, constituents such as the protective case, the control console, the electrical power supply, the control electronics, etc.

### DETAILED DESCRIPTION OF THE PREFERRED EMBODIMENTS

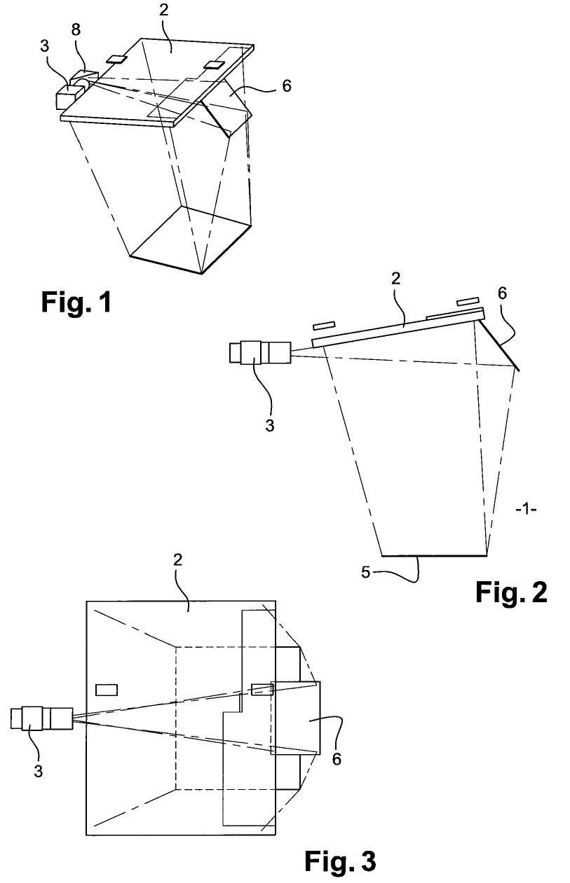

Referring first of all to FIGS. 1 to 3, it becomes apparent that the device 1 comprises a display device 2. In practice, the display device 2 may be an LCD screen which generates one or more stationary images composed of a pattern of alternate light and dark fringes, without this implying that they are completely white and black. On the contrary, in concrete terms, it may be desirable for the profile of the luminous intensity to be as close as possible to a sinusoidal distribution. The use of an LCD screen makes it possible to employ the phase-shift technique by displaying fringes progressively displaced over the surface to be inspected. The LCD screen also makes it possible to display fringes in orthogonal directions, which enables a complete measurement, that is to say that the two orthogonal components of the local slope of the surface may be measured at any point of the measurement field, which provides complete information about the geometry of the surface.

The device 1 additionally comprises a sensor 3. This sensor 3 may be a CCD camera which generally consists of an imaging objective, an image sensor, a system for amplifying the detected signal and a system for encoding the signal, usually in digital form. To this end, the CCD camera comprises photodetectors that convert the radiant energy emitted or reflected by a given phenomenon into a corresponding electrical signal, thereby making it possible to reconstruct the image of this phenomenon.

In the device of the invention, the sensor 3 is used to reconstruct the image generated by the display device 2—a fringe pattern—which is reflected by a surface to be inspected 5. The surface to be inspected 5 may be, without limitation, a metal surface such as a motor vehicle body, a glass, plastic or composite surface, a paper or leather surface, etc.

The device according to the invention is additionally equipped with a deflecting mirror 6. This deflecting mirror 6 is attached by suitable means (not shown) either to the display device 2 or to a case (not shown) in which the entire device is housed.

The presence of the deflecting mirror 6 is of great importance in the structure of the device according to the invention as the deflecting mirror 6 makes it possible to direct the image reflected by the surface to be inspected 5 toward the sensor 3. The latter is positioned between the display device 2 and the surface to be inspected 5. In this position the sensor 3 is of low prominence, which proves to be very advantageous for the overall size requirement of the device.

In the exemplary embodiment shown in FIG. 1, the sensor 3 faces the deflecting mirror 6. In other words, the sensor 3 is oriented so that its acquisition axis is perpendicular to the deflecting mirror 6.

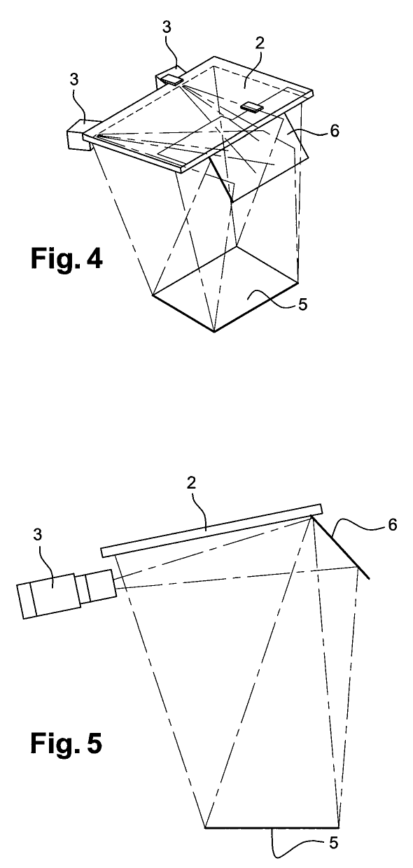

FIGS. 4 and 5 show two embodiments of the invention in which the device is provided with two sensors 3, which makes it possible to extend the field.

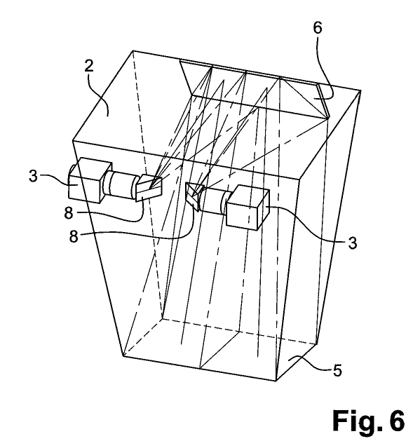

The optimum compactness of the device is obtained when the sensor 3 is oriented parallel to the deflecting mirror 6. FIG. 6 shows this embodiment of the invention in which a prism 8 is located in front of the sensor 3. This arrangement makes it possible to avoid protrusion of the camera body, of its power-supply cables and of the space required to protect them.

In these various embodiments, the pyramid of reflected rays is folded back not behind the display device 2, but on the side of the front face of the display device. This front face is understood to be the face of the display device 2 on which the fringe pattern is generated. In practice, the sensor 3 is attached to the periphery of the display device 2 so as not to disrupt the displaying of the fringe pattern.

It will be noted that, in this embodiment, the deflecting mirror 6 is also attached to the periphery of the display device 2. The performance of this arrangement proves to be particularly good in terms of compactness, as all the constituents are located in the space delimited by the front face of the display device 2 and the surface to be inspected 5.

The possibility is again found of orienting the sensor 3 in order for it to be perpendicular to the deflecting mirror 6 or to be parallel to the deflecting mirror 6. In the latter case, shown in FIG. 8, a reflecting prism 8 is associated with the sensor 3 in order to modify the path of the light rays coming from the deflecting mirror 6 toward the sensor 3. This prism may be replaced by any other reflecting device fulfilling the same function.

The invention thus provides a surface inspection device in which the sensor 3 may be juxtaposed with the display device 2 for displaying the fringe pattern without, for all that, reducing the field of inspection for the measurement.

The principle of the invention is found integrally in these embodiments since a deflecting mirror 6 is found to be present, which directs the image reflected by the surface 5 to be inspected toward two sensors 3.

In these two embodiments, the device may thus integrate a mirror which has greater dimensions than that which is provided in the devices shown in FIGS. 1 to 8.

In the embodiment shown in FIGS. 4 to 6, the deflecting mirror 6 is located on the front side of the display device 2, and prisms make it possible to position the sensors parallel to the edge of the screen. In this particularly compact configuration of the invention, the two sensors 3 are also situated on the front side of the display device 2.

Of course, the invention is not limited to the embodiment described above by way of nonlimiting example; rather, on the contrary, it encompasses all embodiments thereof. Thus, it is conceivable to equip the inspection device with two deflecting mirrors and with two sensors so as to be able to increase the surface to be inspected while preserving a compact size requirement of the device.

1. A device for inspecting surfaces by deflectometry, which comprises:
a display devices designed to generate, on its face called a front face, a pattern of alternate light and dark fringes;
at least one sensor designed to acquire the image reflected by the surface to be inspected positioned on the front face of the display device and at a periphery of the latter; and
a reflecting means positioned in relation to the surface to be inspected so as to direct the image reflected by the surface to be inspected toward the sensor, the display device being oriented in relation to the surface to be inspected at an angle such that the display device is viewed by the sensor at normal incidence.

2. The device as claimed in claim 1, wherein at least one sensor is oriented in a direction parallel to a deflecting mirror and is associated with a return means, of a mirror type or equivalent, which changes a path of light rays coming from the deflecting mirror toward the sensor.

3. The device as claimed in claim 1, wherein the reflecting means is a deflecting mirror.

4. The device as claimed in claim 1, wherein each of the sensors is mounted directly or indirectly on the display device.

5. The device as claimed in claims 3, wherein at least one sensor is oriented in a direction perpendicular to the deflecting mirror.

6. The device as claimed in claim 3, which comprises two sensors oriented in a direction of a deflecting mirror.

7. The device as claimed in claims 1, wherein the display device is an LCD or plasma screen.

8. The device as claimed in one of claims 1, wherein the sensor is a CCD camera.
